(19) United States
(12) Patent Application Publication
(10) Pub. No.: US 2017/0057066 A1
(43) Pub. Date: Mar. 2, 2017

(54) COMPRESSOR CHANGE-OUT TOOL

(71) Applicant: Victor SENEGAL, Katy, TX (US)

(72) Inventor: Victor SENEGAL, Katy, TX (US)

(21) Appl. No.: 15/245,479

(22) Filed: Aug. 24, 2016

Related U.S. Application Data
(60) Provisional application No. 62/209,364, filed on Aug. 25, 2015.

(51) Int. Cl. B25B 27/02

(52) U.S. Cl. CPC B25B 27/02

(57) ABSTRACT

A compressor change-out tool is provided having a plate, a first slot formed through the plate, a second slot formed through the plate, a first bolt received by the first slot and movable within the first slot so as to align with a first bolt hole of the compressor, a second bolt hole received second bolt received by the second slot and movable within the first slot so as aligned with a second bolt hole of a compressor, and a handle affixed to the plate and extending outwardly therefrom. The compressor change out tool is a leverage tool which allows for easy manipulation of a compressor. Preferably, the handle of the compressor change-out tool is a two-piece handle wherein one of the pieces can be removed when workspace around the compressor is limited.

### CROSS-REFERENCE TO RELATED APPLICATIONS

The present application claims priority to U.S. Provisional Application No. 62/209,364, filed on Aug. 25, 2015, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates generally to specialized hand tools and in particular to a compressor change-out tool.

2. Description of Related Art Including Information Disclosed Under 37 CFR 1.97 and 37 CFR 1.98.

The installation and servicing of heating, ventilation, and air conditioning (HVAC) systems in large buildings, as well as commercial refrigeration units in restaurants and other large scale food service locations, has presented unique challenges. For various reasons, the commercial semi-hermetic compressors used to operate such systems are typically installed in very narrow spaces. The compressor is large and heavy, and when the time has come for maintenance work or replacement of an old compressor, the maintenance worker may be unable to lift it out of the small, cramped space. Fortunately, the customary design of the compressor includes two bolt holes to enable the installer to lift and install the compressor, using a specialized dolly.

The specialized dolly available in the market for manipulating compressors is both expensive and cumbersome. As such, most workers do not have such a dolly with them on service calls. Therefore, changing out and manipulating compressors on service calls can be time-consuming and difficult. Additionally, since such compressors are very heavy and cumbersome, changing out the compressors is dangerous, often leading to hand and back injuries.

Various patents have been issued a past relating to leverage tools used in various applications. For example, U.S. Pat. No. 4,577,897, issued on Mar. 25, 1986 to Mazac, describes a lifting tool used for air-conditioning compressors, which differ from the type of compressor that concerns the present invention. The lifting tool the Mazac patent applies vertical forces to the air conditioning compressor. A body carries a catch device for engaging the load and a support mechanism therebelow receives a load and limits the rotational movement of the load about a point of engagement with the catch mechanism. A handle is provided above the load whereby vertical forces may be applied. The handle is collapsible relative to the body for storage purposes.

U.S. Pat. No. 8,434,739, issued on May 7, 2013 to Connolly, describes a demolition leveraging tool. The tool of the Connelly patent has a head which can be connected to various rotationally and positioned fully adjustable tools specifically shaped to achieve various demolition tasks. The two heads are adjustable.

U.S. Pat. No. 5,370,022, issued on Dec. 6, 1994 to Rodriguez et al., describes a fastener driving leverage tool. The tool is useful and loosening corroded or stuck fasteners which are difficult or impossible to remove with conventional tools. The tool is adjustable for a variety of situations and amplifies the force of the user that is exerted on a fastener bit and the fastener head, thereby reducing the chance of the bit slipping off the fastener head.

U.S. Pat. No. 7,389,971, issued on Jun. 24, 2008 to Gaudreault et al., describes a leverage tool for tightening devices. U.S. Pat. No. 3,026,091, issued on Mar. 20, 1962 to Oaks, describes another type of leverage tool.

It is an object of the present invention to provide a compressor change-out tool which replaces the specialized dolly currently used.

It is another object of the present invention to provide a compressor change-out tool which is easy to use and to carry.

It is another object of the present invention to provide a compressor change-out tool which reduces the chance of injury associated with manipulating a compressor.

It is another object of the present invention to provide a compressor change-out tool which significantly reduces the time associated with servicing a compressor.

It is yet another object of the present invention to provide a compressor change out tool which is relatively inexpensive and easy to manufacture.

It is yet another object of the present invention to provide a compressor change out tool which is adjustable for different size compressors.

Finally, it is another object of the present invention to provide a compressor change out tool which is adjustable and adaptable for use in different size workspaces.

These and other objects and advantages of the present invention will become apparent from a reading of the attached specification and appended claims.

### BRIEF SUMMARY OF THE INVENTION

In one embodiment, the present invention is a leverage tool for servicing compressors including a plate, a first slot formed through the plate, a second slot formed through the plate, a first bolt received by the first slot, a second bolt received by the second slot and a handle affixed to the plate and extending outwardly therefrom. Each of the first bolt and second bolt preferably have a thread pattern thereon suitable for receipt by threaded holes of a compressor. The handle is preferably a two-piece handle having a front handle section affixed to the plate, and a rear handle section removably connected to the front handle section. In one embodiment, the handle includes a hollow tube, and a cap removably affixed to an end of the hollow tube opposite the plate. The first bolt and second bolt are storable within the hollow tube.

In the present invention, the first bolt is preferably movable along an axis of the first slot and the second bolt is movable along an axis of the second slot so as to adjust a distance between the first bolt and second bolt. The plate is preferably rectangular. The rear handle section is preferably substantially longer than the front handle section.

In one embodiment, the first bolt and second bolt are removably received by the first slot and the second slot, respectively. In another embodiment, the first bolt and the second bolt are permanently affixed within the first slot and the second slot, respectively.

In one embodiment, the present invention is a compressor change-out tool having a mounting plate having a first aperture and a second aperture formed therethrough, a first bolt received by the first aperture and extending through the mounting plate, the first bolt having a thread pattern thereon, a second bolt received by the second aperture and extending through the mounting plate, the second bolt having a thread pattern thereon, and a handle affixed to the mounting plate. In one embodiment, the first aperture is a slot, and the first bolt is movable along an axis of the slot so as to adjust a distance between the first bolt and the second bolt.

In one embodiment of the compressor change-out tool of the present invention, the handle includes a front handle section affixed to the mounting plate, a rear handle section, and a coupling affixed to both the front handle section and the rear handle section. The coupling may have a diameter larger than a diameter of either of the front handle section and the rear handle section.

In one embodiment, the present invention is a tool for manipulating a compressor, the compressor having a first bolt hole and a second bolt hole thereon, the tool including a plate, a first slot formed through the plate, a second slot formed through the plate, a first bolt received by the first slot, said first bolt movable within the first slot so as to align with the first bolt hole of the compressor, a second bolt received by the second slot, the second bolt movable within the second slot so as to align with the second bolt hole of the compressor, and a handle affixed to the plate and extending outwardly therefrom.

This foregoing Section is intended to describe, in generality, the preferred embodiment of the present invention. It is understood that modifications to this preferred embodiment can be made within the scope of the present invention. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 shows a perspective view of a compressor change-out tool in accordance with the preferred embodiment of the present invention.

FIG. 2 shows another perspective view of the compressor change-out tool of the present invention wherein the hollow nature of the handle is shown.

FIG. 3 shows a top plan view of the compressor change-out tool the preferred embodiment of the present invention being engaged with a compressor.

FIG. 4 shows a perspective view of the compressor change-out tool of the present invention engaged with a compressor.

### DETAILED DESCRIPTION OF THE INVENTION

Referring now to the invention in more detail, the invention is directed to a compressor change-out tool 10.

It is to be understood that while the invention is intended for use in the removal of semi-hermetic compressors, this is not intended as a limitation. With suitable modifications or with no modifications at all, the invention could be used for the installation or removal of any heavy equipment from narrow spaces, which may be lifted and carried by one or two workers, lifting from one end.

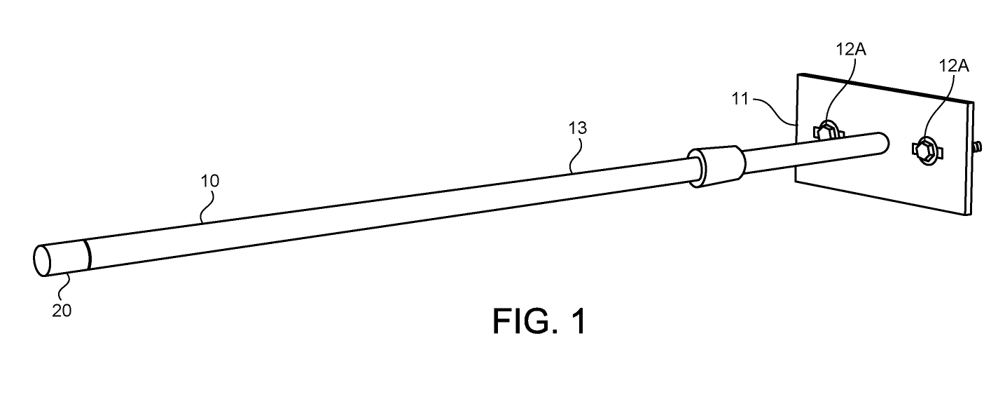

As shown in FIGS. 1-3, the first exemplary embodiment is comprised of a compressor change-out tool 10 which provides a rectangular, vertical mounting plate 11 with two horizontal slots 12, configured such that bolts 13 may be inserted through the slots 12 and affixed to the bolt holes at the end of a semi-hermetic compressor. Preferably, the mounting plate 11 is approximately 0.25 inch in thickness, 7.5 inches in length, and 3.25 inches in height. Preferably, the slots 12 are aligned longitudinally along the centerline of the mounting plate 11, such that bolts 12A inserted through the slots 12 may be affixed to bolt holes which are separated from each other by varying distances.

The bolts 12A may be permanently retained in the slots 12 by rails (not shown), such that the bolts 12A may be easily turned, but cannot be removed from the slots 12. The slots 12 are preferably oval or rectangular in shape, approximately 1.5 inches in length, and 0.25 inches in height.

The tool 10 is further comprised of a two-piece handle 13, with the sections joined by a threaded coupling 16 which is preferably 2 inches in length and provides female threads at each end. The front section of the handle 13 is affixed to the center of the mounting plate 11, providing male threads for insertion into corresponding female threads in a central circular aperture. When the tool 10 is assembled with the mounting plate 11 affixed to the bolt holes, the tool 10 may be used to lift the compressor out of a narrow space for purposes of maintenance or replacement.

Preferably, the front handle section 14 is 9.5 inches in length, providing male threads on both ends, and the rear handle section 15 is 25.5 inches in length, providing male threads on the front end. These lengths have proven to be the most convenient in providing maximum leverage for lifting within the workspaces which are available.

To use the first exemplary embodiment, the user may assemble the handle 13, joining the sections with the coupling 16 which is provided, and then affix the handle 13 to the mounting plate 11. The user may then affix the mounting plate 11 to the bolt holes in the end of the compressor, inserting the bolts 12A which are provided through the slots 12 and affixing the bolts 12A tightly to the bolt holes. The user may then grasp the handle 13 firmly with both hands and lift upward to remove the compressor.

The mounting plate 11, the front handle section 14, the rear handle section 15, and the coupling 16 are preferably manufactured from rigid, durable materials which provide substantial structural strength, such as steel and aluminum alloy.

Alternately, the front handle section 14 and the rear handle section 15 may be constructed from hardwood. Components, component sizes, and materials listed above are preferable, but artisans will recognize that alternate components and materials could be selected without altering the scope of the invention.

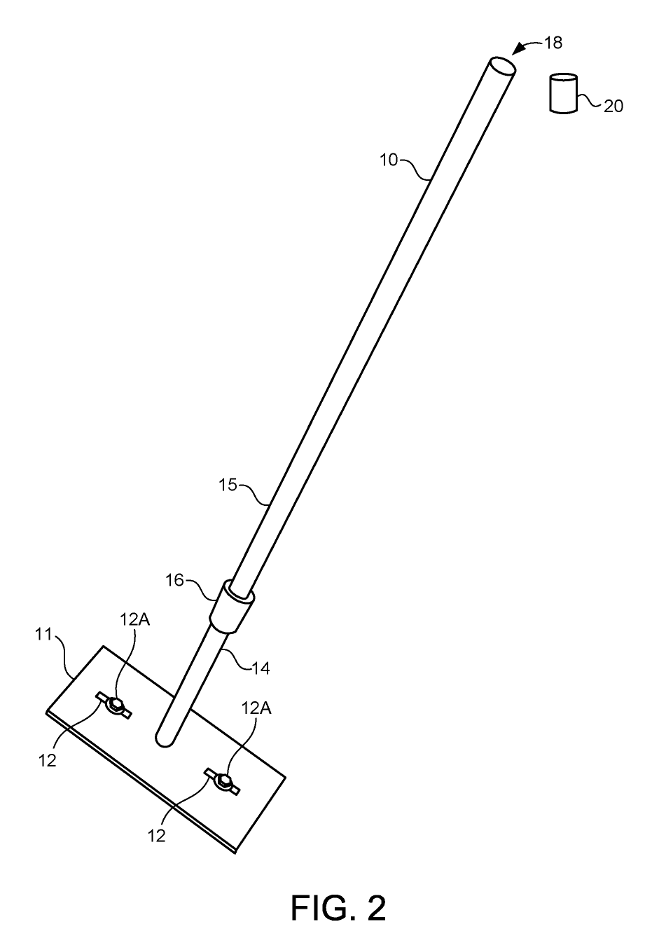

In a preferred embodiment of the present invention, the bolts 12A are removable from the slots 12. In FIG. 2, it can be seen how the rear handle portion 15 comprises a hollow tube. An opening 18 of the hollow tube is shown in FIG. 2. The bolts 12A, once removed from the slots 12, can be stored within the hollow opening 18 of the rear handle portion 15. A cap 20 is provided which serves to cover the opening 18 of the rear handle portion 15. The cap 20 is also shown in FIGS. 1 and 2. The cap 20 can be formed of a plastic material, in one embodiment, which reduces the chance of injury associated with contacting the end of the rear handle portion 15. Storage of the bolts 12A in the rear handle portion 15 makes the compressor change-out tool 10 much easier to store.

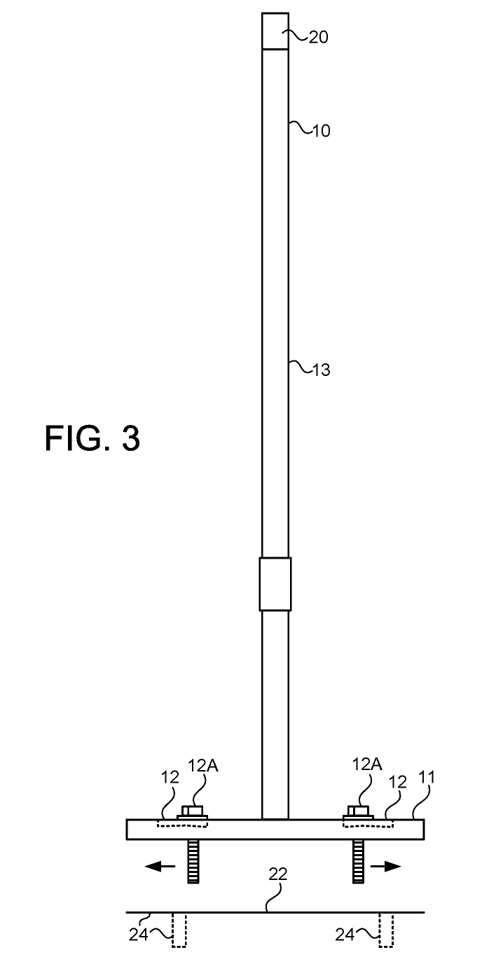

Referring to FIG. 3, it can be easily seen how the bolts 12A are adjustable within the mounting plate 11. The slots 12 are shown in broken lines in FIG. 3. In FIG. 3, it can be seen how the bolts 12A are out of alignment with the bolt holes 24 of the compressor 22. FIG. 3 shows how the bolts 12A can be moved outwardly away from the handle 13 of the compressor change-out tool 10 so as to be aligned properly with the bolt holes 24 of the compressor 22. The bolt holes 24 are found at the oil pump base of the compressor 22. Once the bolts 12A are secured within the bolt holes 24, then the compressor change-out tool 10 can be used to raise the front and rear of the compressor 22 to remove the mounted nuts or spacers under the compressor so as to be easily removed from the compressor frame. It can be appreciated that the compressor change-out tool allows for the compressor to be guided out safely. These same steps also help to install a new compressor by handling and manipulating the weight safely and easily.

While the slots 12 are shown in the figures as being rectangular, it is within the concept of the present invention that the slots 12 can take the form of any aperture allowing the bolts 12A to be positioned therethrough. For example, a compressor change-out tool 10 can be provided wherein the bolts are not adjustable relative to the mounting plate, in the case where a compressor change out tool was designed for specific compressor. However, as can be appreciated, the adjustability of the compressor change-out tool of the preferred embodiment of the present invention could be very advantageous to technicians who encounter different compressors throughout the workday or workweek.

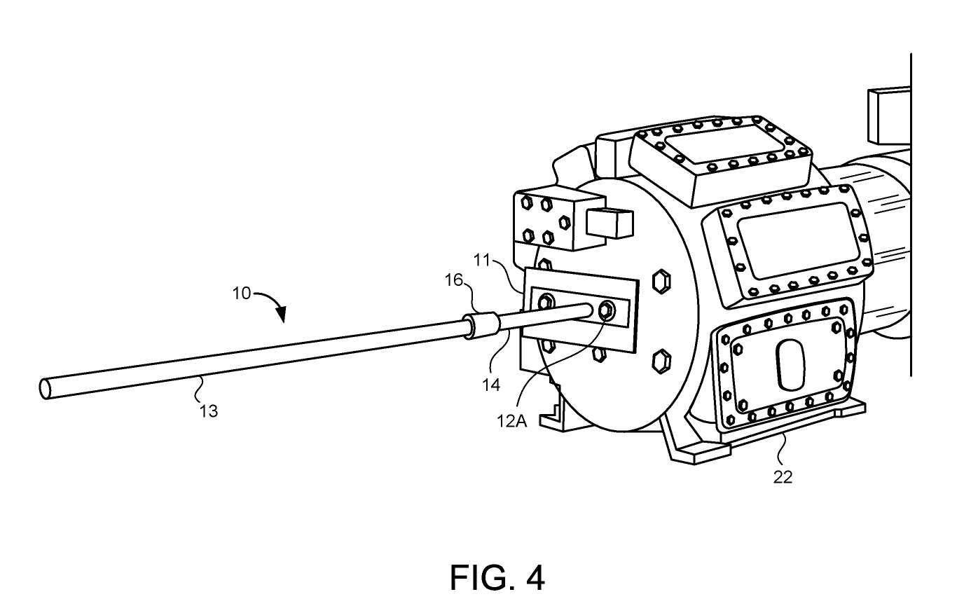

Referring to FIG. 4, there is shown a typical compressor 22. The compressor 22 has a front face to which the compressor change out tool 10 has been affixed. FIG. 4 shows how the mounting plate 11 is positioned against the face of the compressor 22, while the bolts 12A are inserted into the bolt holes of the compressor 22. In the event that it would be difficult to position the entire handle of the compressor change-out tool 10, the handle can be separated such that the front handle portion 14 is only used.

Surprisingly, this relatively simple yet commercially-unavailable tool significantly reduces the time and effort associated with the removal, replacement and servicing of compressors. In the inventor's experience, use of the tool of the present invention reduces the time associated with such work by approximately fifty percent. Further, the tool is adaptable to different compressors and challenging work conditions.

The tool of the present invention is both cheaper and less cumbersome than the only other available solution in the prior art—the specialized dolly. As such, availability of the present invention would enable nearly all workers in the industry to have a tool which provides significant productivity benefits, while protecting against possible injury, which can be both physically and financially burdensome.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A leverage tool for servicing compressors comprising:
a plate;
a first slot formed through said plate;
a second slot formed through said plate;
a first bolt received by said first slot;
a second bolt received by said second slot; and
a handle affixed to said plate and extending outwardly therefrom.

2. The leverage tool of claim 1, each of said first bolt and second bolt having a thread pattern thereon suitable for receipt by threaded holes of a compressor.

3. The leverage tool of claim 1, said handle comprising:
a front handle section affixed to said plate; and
a rear handle second removably connected to said front handle section.

4. The leverage tool of claim 1, said handle comprising:
a hollow tube; and
a cap removably affixed to an end of said hollow tube opposite said plate, said first bolt and said second bolt being storable within said hollow tube.

5. The leverage tool of claim 1, said first bolt movable along an axis of said first slot and said second bolt movable along an axis of said second slot so as to adjust a distance between said first bolt and said second bolt.

6. The leverage tool of claim 1, said plate being rectangular.

7. The leverage tool of claim 3, said rear handle section being substantially longer than said front handle section.

8. The leverage tool of claim 1, said first bolt and said second bolt being removably received by said first slot and said second slot, respectively.

9. The leverage tool of claim 1, said first bolt and said second bolt being permanently affixed within said first slot and said second slot, respectively.

10. A compressor change-out tool comprising:
a mounting plate having a first aperture and a second aperture formed therethrough;
a first bolt received by said first aperture and extending through said mounting plate, said first bolt having a thread pattern thereon;
a second bolt received by said second aperture and extending through said mounting plate, said second bolt having a thread pattern thereon; and
a handle affixed to said mounting plate.

11. The compressor change-out tool of claim 10, said bolt pattern of said first bolt and said bolt pattern of said second bolt being suitable for receipt by threaded holes of a compressor.

12. The compressor change-out tool of claim 10, said first aperture comprising a slot, said first bolt movable along an axis of said slot so as to adjust a distance between said first bolt and said second bolt.

13. The compressor change-out tool of claim 10, said handle comprising:
a front handle section affixed to mounting plate;
a rear handle section; and
a coupling affixed to both said front handle section and said rear handle section.

14. The compressor change-out tool of claim 13, said coupling having a diameter larger than a diameter of either of said front handle section and said rear handle section.

15. The compressor change-out tool of claim 13, said rear handle section comprising:
a hollow tube; and
a cap affixed over an end of said hollow tube opposite said coupling.

16. The compressor change-out tool of claim 13, said rear handle section being substantially longer than said front handle section.

17. The compressor change-out tool of claim 10, said first bolt and said second bolt being removably received by said first aperture and said second aperture, respectively.

18. The compressor change-out tool of claim 10, said first bolt and said second bolt being permanently affixed within said first aperture and said second aperture, respectively.

19. The compressor change-out tool of claim 13, said first bolt and said second bolt being storable within said hollow tube of said rear handle section.

20. A tool for manipulating a compressor, the compressor having a first bolt hole and a second bolt hole thereon, the tool comprising:
a plate;
a first slot formed through said plate;
a second slot formed through said plate;
a first bolt received by said first slot, said first bolt movable within said first slot so as to align with the first bolt hole of the compressor;
a second bolt received by said second slot, said second bolt movable within said second slot so as to align with the second bolt hole of the compressor; and
a handle affixed to said plate and extending outwardly therefrom.
